(19) United States
(12) Patent Application Publication
(10) Pub. No.: US 2003/0077555 A1
(43) Pub. Date: Apr. 24, 2003

(54) Coaching device and method of use

(76) Inventor: John Stewart Soppit, Candiac (CA)

Correspondence Address: OGILVY RENAULT, 1981 MCGILL COLLEGE AVENUE, SUITE 1600, MONTREAL, QC, H3A2Y3, CA

(21) Appl. No.: 09/981,255

(22) Filed: Oct. 18, 2001

(51) Int. Cl. G09B 9/00; G09B 19/00; A63B 69/00

(52) U.S. Cl. 434/247

(57) ABSTRACT

A method for interactive coaching, comprising the steps of i) providing a representation of a downscaled regulation playing field of a predetermined sport; ii) providing at least two participants with items representing players on the playing field; and iii) causing the participants to displace the items on the representation and simulate plays and strategies for interactively teaching the predetermined sport to the participants. The representation is a panel having a surface thereof provided with markings defining the downscaled regulation playing field. The panel is sized for allowing participants to gather around the panel and is made of a lightweight and foldable material such that it can be easily transported.

### BACKGROUND OF THE INVENTION

1. Field of the Invention

The present invention generally relates to a coaching device for teaching individuals strategies and plays of given sports.

2. Description of the Prior Art

Blackboards, drawing boards and other teaching aids have emerged out of classrooms to be used in a plurality of applications. One such application is the coaching of sports. For instance, drawing boards are commonly seen in use during the time-outs of the dying seconds of close games, whether it be in hockey, football, basketball or most other team sports. Such drawing boards and other coaching aids are also useful in practices in order to illustrate various plays and strategies. U.S. Pat. No. 5,263,866, issued on Nov. 23, 1993 to Campbell, U.S. Pat. No. 2,579,105, issued on Dec. 18, 1951 to Baldine, and U.S. Pat. No. 5,626,478, issued on May 6, 1997 to Gatlin are a few examples of coaching devices found in the above described applications. Such coaching devices are useful in theoretically coaching and teaching strategies and plays.

As professional athletes have a good knowledge of their sports, they can easily understand and apply the plays and strategies shown symbolically on such coaching devices. The basics of sports are, however, often taught or shown to younger athletes, which may often encounter problems in understanding theories symbolically shown.

In schools, a pedagogical trend having youths learning by experience is well-known and used for easing the teaching of theory. This active pedagogy involves the kids interactively, and the levels of concentration and understanding of the kids are increased by their involvement. The kids thus learn from what they have experienced.

### SUMMARY OF THE INVENTION

It is therefore an aim of the present invention to provide a coaching device interactively involving a learning audience.

It is also an aim of the present invention to provide a method for interactively teaching a sport.

Therefore, in accordance with the present invention, there is provided a method for interactive coaching, comprising the steps of i) providing a representation of at least a portion of a downscaled regulation playing field of a predetermined sport; ii) providing at least two participants with items representing players on said playing field; and iii) causing the participants to displace said items on said representation and simulate plays and strategies for interactively teaching the predetermined sport to the participants.

Also in accordance with the present invention, there is provided An interactive coaching device comprising a panel having at least a first surface thereof provided with markings defining at least a portion of a downscaled regulation playing field of a predetermined sport, said panel being sized for allowing a plurality of participants to gather around said panel; and items representing players on said playing field, said items being adapted to be displaced thereon in an unrestricted fashion by the participants so as to illustrate player displacement and positioning on said playing field, whereby the participants displace said items on said playing field for simulating plays thereon, thereby causing the participants to interactively learn the predetermined sport.

### BRIEF DESCRIPTION OF THE DRAWINGS

Having thus generally described the nature of the invention, reference will now be made to the accompanying drawings, showing by way of illustration a preferred embodiment thereof, and in which:

FIG. 1 is a top plan view of a coaching device in accordance with the present invention; and

FIG. 2 is a cross-sectional view of a taken along cross-section line 2-2 of FIG. 1 showing a reinforcement sleeve of the coaching device.

### DESCRIPTION OF THE PREFERRED EMBODIMENTS

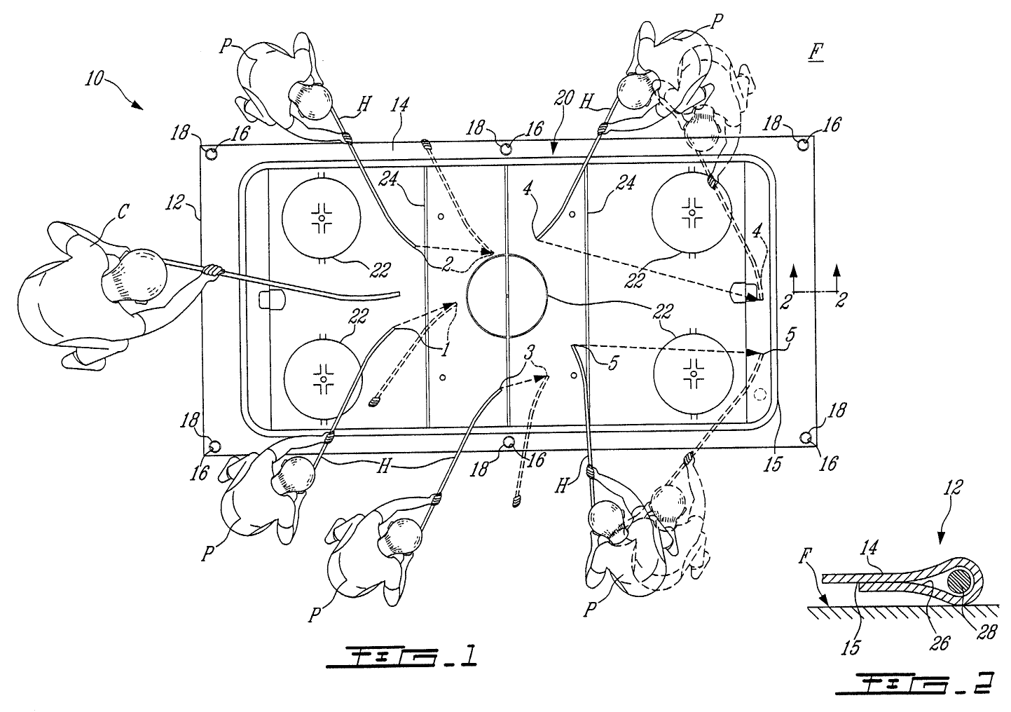

According to FIG. 1, a coaching device of the present invention is generally shown at 10. A plurality of pupils or participants P and a coach C stand around the coaching device 10. The coaching device 10 is defined by a panel 12 having a top surface 14 and a bottom surface 15 lying on a floor F. Holes 16 are defined along the periphery of the panel 12. As herein shown, six holes 16 extend through the panel 12, three of these holes 16 being equidistantly spaced on opposed longitudinal sides of the panel 12. Grommets 18 are added to reinforce the panel 12 around the holes 16. The holes 16 and the grommets 18 are provided for securing the coaching device 10 to a floor F as shown in FIG. 1, to a wall (not shown), or to an outdoor field using stakes or the like. As shown in FIG. 2, the periphery of the panel 12 is folded (e.g. 2″ fold) and adhered to the bottom surface 15 (e.g. using a heat adhesive) in order to define a sleeve 26 for accommodating a reinforcing member such as a cord 28.

The top surface 14 is illustrated by field markings 20, which define a downscaled field of a given sport. As illustrated in FIG. 1, the field markings 20 define an ice hockey rink. For instance, the face-off circles are shown at 22, and the blue lines are shown at 24. Although an ice hockey rink is shown in FIG. 1, the top surface 14 may be illustrated with a basketball court, a football field, a soccer field or any other sport playing surface. It has also been thought to provide the bottom surface 15 with field markings in order to have back-to-back field illustrations on both the top surface 14 and the bottom surface 15. Consequently, one coaching device 10 may serve for coaching two sports. It is also pointed out that the illustrations may represent only a portion of a field. For instance, the top surface 14 may be a full ice hockey rink as shown in FIG. 1, whereas the bottom surface 15 may represent the portion of the rink extending between the boards behind the goaltender net and the nearest blue line, whereby the coaching device 10 can be used to focus on the play in the offensive/defensive zone, such as in man advantage situations.

The panel 12 typically consists of a material which is tear resistant, foldable, lightweight (e.g. less than 1 lb. is suitable), and preferably waterproof. For instance, plastics such as PEVA (i.e. poly(ethyl vinyl acetate), a PE and EVA blend produced film) is an innocuous and environmentally safe material which is ideal for being used as the coaching device 10. The field markings 20 are preferably defined by a one or two color printing process depending on the sports surface being represented thereby. As examples, the ice hockey rink illustration involves a white panel having blue and red lines printed thereon, whereas a soccer field representation comprises a green panel 10 having white lines printed thereon. A laminate plastic film may be added to the panel 12 in order to further protect the top surface 14 and the bottom surface 15 thereof. The plastic surface of the panel 12 advantageously allows the use of dry erase pens thereon in order to indicate various elements on the playing surface. However, as will be explained hereinafter, the main objective of the present invention is not for the panel 12 to serve solely as a drawing board.

Now that the coaching device 10 has been described in detail, the method of use will now be explained. The coaching device 10 is sized in order for a plurality of participants P to stand around it. As depicted in FIG. 1, five participants P and a coach C are spaced around the coaching device 10 so as to be free to move. Other participants (not shown), for instance the other members of a hockey team, may sit or stand around the coaching device 10 Each participant P is provided with an item representing a player on the field markings 20 of the panel 12. As the panel 12 of the coaching device 10 of FIG. 1 illustrates an ice hockey rink, items symbolizing players of the downscaled hockey rink, which are part of the coaching device 10, may be represented by the tips of the hockey sticks H of the participants P.

Accordingly, the tips of hockey sticks H of three participants P may symbolize three forwards 1, 2 and 3, whereas the tips of the sticks H of two other participants P may represent defensive players 4 and 5 defending against the three forwards 1, 2 and 3. Coach C may illustrate a puck with his hockey stick tip. Alternatively, the participants P and the coach C may hold their sticks H upside-down, that is by holding the stick at its blade end while the butt end of the stick H is located onto, or adjacent, the panel 12 such as to represent the players 1, 2, 3, 4 and 5. This alternative may be advantageous as the butt ends of the sticks H take less room on the panel 12 than the blade ends thereof. Also shown in FIG. 1 are arrows illustrating examples of the displacement of the players 1 to 5 according to specific hockey plays. The participants P are guided by the coach C in order to execute various patterns on the coaching device 10 in order to illustrate various plays, or must decide, without or with limited direction from the coach C, their respective displacements as a practice play develops on the panel 12, i.e. with each participant P displacing its hockey stick H in accordance with its selected player positions in response to the player displacements of the other participants P.

Although the coaching device 10 has been described for a hockey coaching usage involving hockey sticks H as players, the downscaled players may also be symbolized by a plurality of other items. Accordingly, a sport like soccer which does not involve any stick, may use various small items (e.g. colored dowels, figurines, screwable studs for soccer cleats, retractable pointers) in order to illustrate the players of the coaching device 10.

The device 10 is thus sized in order to provide plenty of space for the participants P to move around it or to displace their respective player symbolizing items. For instance, a 100 cm×200 cm panel 12 provides adequate dimensions in order for young age participants to interactively demonstrate sport strategies.

The coaching device 10 is versatile in allowing for coaches to demonstrate most any strategy. In the hockey example, the coach may decide to simulate a five-man zone breaking situation or a five against four power-play. Similarly, a basketball coach may illustrate with the coaching device 10 a zone defense or a man-to-man defense. As field time is precious due to a lack of fields, the coaching device 10 allows for locker room or off-site interactive demonstrations, whereby the field time may be extensively and optimally used for focusing on physical training and practicing. Again, the participants may develop the play on the panel 12 without the coach's input, or with corrective input from the coach C, when required.

As the coaching device 10 is easily displaceable (e.g. the panel 12 thereof may be foldable or rollable to fit a coach's bag, and the sticks H are also easily carried), it may be brought to the bench in order to illustrate various strategies during time-outs or during intermissions. In this event, the dry erase markers may be advantageously used. The fact that the participants P actively participate in demonstrating, or even creatively developing, a specific strategy of a given sport helps them to experience the strategy and visualize it, whereby their learning of the strategy is facilitated.

I claim:

1. A method for interactive coaching, comprising the steps of:
i) providing a representation of at least a portion of a downscaled regulation playing field of a predetermined sport;
ii) providing at least two participants with items representing players on said playing field; and
iii) causing the participants to displace said items on said representation and simulate plays and strategies for interactively teaching the predetermined sport to the participants.

2. The method according to claim 1, wherein the predetermined sport is hockey and the playing field is a hockey rink.

3. The method according to claim 2, wherein said items are ends of hockey sticks.

4. An interactive coaching device comprising:
a panel having at least a first surface thereof provided with markings defining at least a portion of a downscaled regulation playing field of a predetermined sport, said panel being sized for allowing a plurality of participants to gather around said panel; and
items representing players on said playing field, said items being adapted to be displaced thereon in an unrestricted fashion by the participants so as to illustrate player displacement and positioning on said playing field, whereby the participants displace said items on said playing field for simulating plays thereon, thereby causing the participants to interactively learn the predetermined sport.

5. The interactive coaching device according to claim 4, wherein said playing field is a hockey rink.

6. The interactive coaching device according to claim 5, wherein said items representing players are ends of hockey sticks.

7. The interactive coaching device according to claim 4, wherein said panel is at least one of foldable, rollable and lightweight for being transported.

8. The interactive coaching device according to claim 7, wherein said panel is a plastic sheet.

9. The interactive coaching device according to claim 4, wherein said panel comprises a plurality of holes on a periphery thereof, said holes being adapted for receiving securement members for securing said panel to one of a wall, a floor and an outdoor field.

10. The interactive coaching device according to claim 9, wherein said holes are reinforced by grommets.

11. The interactive coaching device according to claim 4, wherein said panel has a reinforcing member on at least a portion of a periphery thereof.

12. The interactive coaching device according to claim 11, wherein said reinforcing member is a cord member inserted in a sleeve extending along at least part of the periphery of said panel.

13. The interactive coaching device according to claim 4, wherein said first surface of said panel is made of a material adapted for receiving erasable pen markings thereon.

14. The interactive coaching device according to claim 4, wherein at least a portion of a downscaled regulation playing field of a predetermined sport is provided on each of a pair of opposite surfaces of said panel.
